(19) United States
(12) Patent Application Publication
(10) Pub. No.: US 2004/0094570 A1
(43) Pub. Date: May 20, 2004

(54) Operating element for hand operated bottle pump

(76) Inventor: Yau Fook Ho, Honk Kong (HK)

Correspondence Address: JACKSON WALKER L.L.P., Suite 2100, 112 E. Pecan Street, San Antonio, TX, 78205, US

(21) Appl. No.: 10/294,738

(22) Filed: Nov. 14, 2002

(51) Int. Cl. B67D 5/32

(52) U.S. Cl. 222/39; 222/209

(57) ABSTRACT

An operating element for a hand operated bottle pump includes a housing for engaging a plunger of a pump, a sound module located within the housing, and an activation means for activating the sound module when the plunger of the pump is depressed. The housing comprises two portions engaged at an equator for movement between a first position and second position. The activation means is secured to one portion and the sound module is secured to the other portion for activation when the two portions are in the second position. The two portions are biased in the first position.

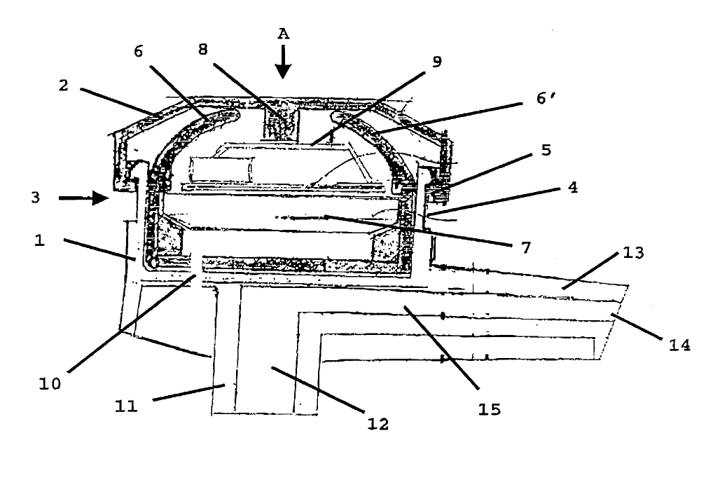

### BACKGROUND TO THE INVENTION

1. Field of the Invention

The invention relates to hand operated bottle pumps and the like, and in particular to an operating element for a hand operated bottle pump.

2. Background Information

Hand operated bottle pumps are well-known. U.S. Pat. No. 3,257,961 issued to Schlenker in 1966 describes such a pump. It comprises a bottle closure with a cylinder. At the lower end of the cylinder is an inlet passage closed by a one-way valve. A spring biased plunger extends into the cylinder. The pump is operated by depressing the plunger into the cylinder to force liquid in the cylinder through a delivery passage in the plunger. When the plunger is released the spring moves the plunger back out of the cylinder and liquid flows in through the inlet passage to recharge the cylinder for the next operation.

Pumps of this nature are widely used for dispensing personal hygiene products such as liquid soap, shampoo, hair conditioner, skin lotions, toothpaste and the like.

### SUMMARY OF THE INVENTION

It is an object of the present invention to provide an operating element for a hand operated bottle pump which can be used for festive or informative purposes or which at least provides the public with useful alternative.

According to a first aspect of the invention there is provided an operating element for a hand operated bottle pump including a housing for engaging a plunger of a pump, a sound module located within the housing, and an activation means for activating the sound module when the plunger of the pump is depressed.

Preferably, there is an aperture in an underside of the housing for emitting sound from the sound module.

Preferably, the housing comprises two portions engaged at an equator for movement between a first position and second position, the activation means is secured to one of said portions and the sound module is secured to the other of said portions for activation when the two portions are in the second position, and a bias means for biasing the two portions in the first position and accommodating movement of the two portions to the second position.

Preferably, the housing has a bore for receiving the plunger of the pump, a nozzle with an aperture at its distal end, and a passage from the bore to the aperture for conveying a liquid from the pump.

Further aspects of the invention will become apparent from the following description, which is given by way of example only.

### BRIEF DESCRIPTION OF THE DRAWINGS

An embodiment of the invention will now be described by way of example only and with reference to the accompanying drawing, which illustrates an operating element according to the invention.

### DESCRIPTION OF THE PREFERRED EMBODIMENT

An operating element for a hand operated bottle pump comprises a housing for engaging a plunger of a pump (not shown). The housing comprises a lower portion 1 and an upper portion 2 engaged at an equator 3. The lower portion 1 has a recess 4 about an upper periphery. A lip 5 about the lower periphery of the upper portion 2 engages with the recess 5 for retaining the two portions and facilitating relative movement of the two portions between a first position and a second position. Two resilient arms 6, 6′ extend upwardly and inwardly and engage against the upper portion 2 to bias the two portions in the first position. The arms 6 deform to accommodating movement of the two portions to the second position.

A sound module 7 is secured within the lower portion 1. An activation arm 8 is secured to the underside of upper portion 2 and projects downwardly towards a metallic tab 9 on the sound module 7. When the lower and upper portions 1, 2 are moved to the second position the activation arm 8 depresses the metallic tab 9 engaging it against a metallic surface on sound module 7 to activate the sound module 7. One or more apertures 10 are provided in the underside of lower portion 1 for emitting sound from the sound module 7.

The sound module 7 is of a type commonly found in childrens toys which play a tune or spoken phrase when activated by squeezing the toy.

The lower portion 1 has a downwardly extending skirt 11 defining a bore 12 for receiving the plunger of the pump (not shown). A dispensing nozzle 13 extends horizontally from the lower portion 1 and has an aperture 14 at its distal end. A passage 15 from the bore 12 to the aperture 14 conveys liquid from the pump.

The pump is of a type known in the art. Such a pump is described in U.S. Pat. No. 3,257,961 issued to Schlenker in 1966. When the plunger of this pump is depressed liquid is ejected through a passage in the plunger. The operating element of the invention locates on the plunger. To depress the plunger the user presses the housing as indicated by arrow A. The liquid passes along passage 15 and is ejected from nozzle 14. At the same time the two housing portions 1, 2 are moved to the second position and the sound module 7 is activated to play a tune or spoken phrase.

In an alternative embodiment the operating element may be part of a trigger type dispensing pump. In this type of device the operating element may be the pump trigger or another element operated by movement of the trigger to activate the musical module.

The invention may be used on dispensers for personal hygiene products such as liquid soap, shampoo, hair conditioner, skin lotions, toothpaste and the like.

The sound module can play a seasonal tune, for example a Christmas jingle, or an educational message, for example to remind children about washing hands or cleaning teeth, or an animal voice, for example the voice of duck, horse, or a short song sung by human beings, with or without musical accompaniment.

A hand operated bottle pump with an operating element according to the invention can be used for festive or informative purpose and for daily household uses and for commercial uses.

Where in the foregoing description reference has been made to integers or elements have known equivalents then such are included as if individually set forth herein.

Embodiments of the invention having been described, however it is understood that variations, improvements or modifications can take place without departure from the spirit of the invention or scope of the appended claims.

What is claimed is:

1. An operating element for a hand operated bottle pump including a housing for engaging a plunger of a pump, a sound module located within the housing, and an activation means for activating the sound module when the plunger of the pump is depressed.

2. The operating element of claim 1 including an aperture in an underside of the housing for emitting sound from the sound module.

3. The operating element of claim 1 wherein the housing comprises two portions engaged at an equator for movement between a first position and second position, the activation means is secured to one of said portions and the sound module is secured to the other of said portions for activation when the two portions are in the second position, and a bias means for biasing the two portions in the first position and accommodating movement of the two portions to the second position

4. The operating element of claim 1 wherein the housing has a bore for receiving the plunger of the pump, a nozzle with an aperture at its distal end, and a passage from the bore to the aperture for conveying a liquid from the pump.
